(19) United States
(12) Patent Application Publication
(10) Pub. No.: US 2011/0221101 A1
(43) Pub. Date: Sep. 15, 2011

(54) Resin-based molding of electrically conductive structures

(76) Inventor: David J. Legare, Ava, NY (US)

(21) Appl. No.: 12/932,341

(22) Filed: Feb. 23, 2011

Related U.S. Application Data
(60) Provisional application No. 61/339,860, filed on Mar. 10, 2010.

(51) Int. Cl. B29C 45/14

(52) U.S. Cl. 264/430; 264/135; 264/257; 264/265

(57) ABSTRACT

A method for resin-based molding of electrical structures which possess desired properties of electrical conductivity, radio frequency (RF) energy reflectivity, and electromagnetic interference (EMI) shielding, while still retaining the basic physical and structural properties of the base (plastic) material.

### PRIORITY CLAIM UNDER 35 U.S.C. §119(e)

This patent application claims the priority benefit of the filing date of provisional application Ser. No. 61/339,860, having been filed in the United States Patent and Trademark Office on Mar. 10, 2010 and now incorporated by reference herein.

### STATEMENT OF GOVERNMENT INTEREST

The invention described herein may be manufactured and used by or for the Government of the United States of America for governmental purposes without the payment of any royalty thereon.

### BACKGROUND OF THE INVENTION

1. Technical Field of the Invention

This invention relates generally to the field of fabrication techniques for the production of electrically conductive structures. More specifically, the present invention relates to the thermoplastic molding of electrical structures which possess desired properties of electrical conductivity, radio frequency (RF) energy reflectivity, and electromagnetic interference (EMI) shielding, while still retaining the basic physical and structural properties of the base (plastic) material. Applications for the present invention include but are by no means limited to the production of component parts of stowable antenna structures to be used with lightweight, portable, satellite communications ground terminals.

2. Background and Prior Art

By way of example to demonstrate the necessity for plastic-formed conductive and reflective electronic components, consider the field of satellite communications. Communication by satellite is essential in remote locations of the world where terrestrial communications networks do not exist. Moreover, when moving about remote locations, satellite communications equipment must be mobile. Smaller, lighter satellite communications equipment affords greater mobility. Satellite communications in the higher frequency bands such as X, K and Ku require a minimum transmit and receive directed gain that is much higher than the non-directional gain of handheld satellite transceivers in the L-band. Therefore, to achieve the necessary directional gain, mobile satellite transceivers in the X, K and Ku bands require directional antenna systems generally comprising parabolically shaped reflecting surfaces.

Generally speaking, while electronics have become smaller and more efficient over the years, minimum antenna size remains bounded by the physics of electromagnetic radiation and the need for larger physical antenna size (i.e., aperture) to achieve a higher directed gain. It is not uncommon for antenna systems to comprise the least transportable component of modern portable satellite transceivers.

Efforts have been made to achieve a higher degree of transportability of satellite communications antenna systems. Early efforts employed umbrella-like unfolding antennas comprising Mylar material stretched over lightweight metallic frameworks. Other efforts incorporated parabolic-shaped recesses into the satellite terminal enclosures themselves. Many others efforts involved assembling sections of flat or semi-flat panels into mosaics to achieve a larger reflecting surface. While some of these designs may indeed increase directed gain at low satellite frequencies such as in the L-band, they provide inherently unacceptable directive gain at X, K and Ku bands. The constraint which prior attempts at portable designs face at higher frequencies is their inability to provide true parabolic reflecting surfaces necessary for narrow, focused (i.e., directed) beamwidths required not only for gain, but also for discriminating among adjacent geostationary satellites position in equatorial orbits.

What the prior art fails to provide and what is needed, therefore, is a means to produce light weight, dimensionally stable and rigid, geometrically accurate, electrically conductive and RF reflective structures for exemplary applications including transportable radio frequency antennas.

### OBJECTS AND SUMMARY OF THE INVENTION

The present invention provides a method for producing resin-based, non-metallic structures having properties of electrical conductivity, radio frequency (RF) reflectivity, and electromagnetic interference shielding.

It is therefore an object of the present invention to provide a method for incorporating a metalized substrate into a non-metallic molded structure.

It is a further object of the present invention to provide a method for producing metalized substrates from non-metallic materials.

It is still a further object of the present invention to provide a method for injection molding non-metallic structures incorporating metallic substrates from both thermoplastic resins and chemically cure-setting resins.

It is yet still a further object of the present invention to provide a method for producing lightweight and dimensionally stable component parts of radio frequency antennas, EMI shielded enclosures, and the like, using non-metallic base materials.

Briefly stated, the present invention achieves these and other objects by providing a method for resin-based molding of electrical structures which possess desired properties of electrical conductivity, radio frequency (RF) energy reflectivity, and electromagnetic interference (EMI) shielding, while still retaining the basic physical and structural properties of the base (plastic) material.

In a fundamental embodiment of the present invention, a method for resin-forming electrically conductive and reflective structures, a metalized substrate is affixed to a surface of a mold cavity where the cavity has the precise shape and volume of the desired molded structure. The metalized substrate is loosely conformed to the surface of the mold cavity. A first resin mixture is flowed into the mold cavity under pressure and fills the cavity while forcing the metalized substrate material into accurate and complete conformance to the mold cavity surface, while (the metalized substrate material) becomes integrally bonded to the resin material. When the resin mixture cools, cures, or otherwise is solid, the structure is removed from the mold.

Still according to a fundamental embodiment of the present invention, thermoplastic resins are employed to mold structures over an incorporated metallic substrate.

Yet still according to a fundamental embodiment of the present invention, a metalized substrate is produced by metal deposition on carbon fiber or fiberglass cloth.

Still yet according to a fundamental embodiment of the present invention, a metalized substrate is pre-impregnated with resin to ensure complete encapsulation of the metalized substrate within the finished molded structure.

The above and other objects, features and advantages of the present invention will become apparent from the following description read in conjunction with the accompanying drawings, in which like reference numerals designate the same elements.

### BRIEF DESCRIPTION OF THE DRAWINGS

FIG. 1 depicts a segmented parabolic satellite terminal antenna produced by the present invention.

### DETAILED DESCRIPTION OF THE PREFERRED EMBODIMENT

The present invention describes a method for fabricating electrically conductive and reflective structures by mold-forming.

The method of the present invention process comprises the steps of over-molding of a metalized (or otherwise electrically conductive and reflective) fabric that is attached to one surface of a mold, or otherwise suspended in the mold, so that liquid plastic substrate material (or “resin”) flows over it (after the mold is closed), causing the fabric to conform to one surface of the mold and permanently fuse and/or bond to the plastic substrate.

A major goal of the present invention is to assure that the fabric is completely permeated by the melted resin so that the surface quality of the finished part has essentially the same look and feel that the substrate material would have without the embedded fabric. In other words, the process of making the structure electrically conductive and reflective does not degrade the mechanical fidelity of the structure. Thus, in most applications, the conductive fabric layer would be completely conformal to the mold surface, at just a miniscule depth (a few thousandths of an inch or so) below the structure's surface.

Candidate fabrics will generally be fairly thin (less than 0.010″) and sufficiently porous to allow pre-impregnation with a molding-compatible resin material prior to molding. Alternatively, the fabric will have suitability for permeation by the substrate material during the course of the injection molding process, as described in detail below.

The base fabric could be any number of materials appropriate for any number of desired end-use applications. However, current embodiments of the invention employ a non-woven carbon fiber or glass cloth (about 0.003″ to 0.004″ thick) which is first metal coated by one or more chemical vapor or similar deposition processes which coat the individual fibers of the fabric with a microscopically thin layer of metal, with the resulting fabric retaining its mechanical flexibility and porosity, while becoming electrically conductive and RF reflective. In its most basic form, the metalized raw fabric can be placed into the mold, and molded over with the base resin material. Depending on the molding resin material and the process parameters of the molding process (temperatures, injection pressures), at least with thermoplastic materials, this results (in not all, but most cases) in a molded part in which the thermoplastic partially permeates and fuses to one side of the metalized fabric, but the other side (mold surface side) is uncoated, and thus has exposed fabric. It is within the scope of the invention that the uncoated side could be post-coated (with paint, for example) to cover and encapsulate the exposed fabric fibers, but it would seem more desirable to fully encapsulate the entire thickness (through and including both sides) of the fabric during the injection molding step. Thus, steps that pre-impregnate the fabric may be desired and further comprise the scope of the present invention. Pre-impregnation may also be desired even in those cases where the molding step permeates, but does not completely permeate the fabric, in order to provide for a more durable and aesthetically acceptable surface.

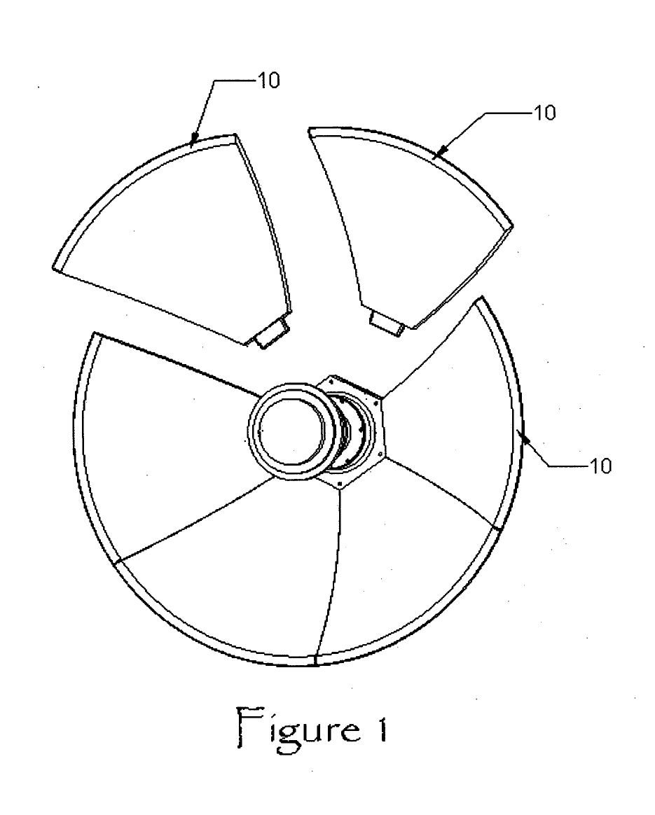

The following describes detailed anticipated and experimentally verified applications of the present invention to a few specific product applications. Referring to FIG. 1, the application of immediate interest is the production of an 18″ diameter parabolic satellite communications antenna reflector comprised of 6 identical segments 10 that plug into a center hub/feed assembly to form the complete reflector. Each segment (petal) 10 is individually molded via the above process to have an RF-reflective surface sufficient to give the antenna a high efficiency rating (close to that for the same geometry made from solid aluminum).

The present invention contemplates the thermoplastic injection molding Of the antenna petals 10 (6 petal segments to form an 18″ parabolic reflector). The present invention method places the conductive cloth layer in the mold (using tape or some other temporary means to hold it in place before the plastic is injected over it) so that it covers the reflective surface of the final product, and to similarly mold the thermoplastic over it.

In preliminary tests, the plastic fuses to the cloth layer, but does not penetrate completely, thus creating a rough (yet still conductive) reflective surface. The present invention therefore employs a further step of creating the desired smooth surface by first coating (or saturating) the conductive cloth (or mold surface which it covers) with a thin layer of liquid epoxy resin (a premixed two part resin that cures over time) or by similarly using a thermoplastic material such as ABS (a candidate material for use in the molding machine as well) dissolved in an appropriate solvent such as acetone to coat the mold or the cloth. Note that the plastic repolymerizes when the solvent evaporates. A successful method for applying the solvent-dissolved (ABS) resin is to mix it to a concentration close to the viscosity of paint, and apply it with a conventional paint spray gun. The material can be applied in one or more layers to either one or both surfaces of the cloth, and then allowed to thoroughly dry before being cut and placed in the injection mold. When the mold subsequently closes and the hot (at about 400 to 700 degree F., depending on the material) thermoplastic is injected into the mold under normal molding pressures (typically over 1000 PSI), the cloth should completely fuse to the injected plastic (which forms the bulk of the finished part) and completely conformed to the working side of the finished part to form a smooth, RF reflective surface.

Besides the advantage of providing for durable, light-weight parts, the present invention allows for the use of fairly inexpensive raw materials and high production rates due to the fast cycle times of the injection molding process (on the order of 10's of seconds to a few minutes). Note that the injection molding tool could be Teflon coated to prevent excessive adhesion of the epoxy coating (if epoxy is used; however, not necessary if the material used to coat the cloth is the aforementioned resin-dissolved thermoplastic) to the mold surface. Also note that the above technique can similarly be used to produce other desirable articles such as light-weight, durable enclosures (i.e., to house sensitive electronic systems) which have excellent EMI properties very similar to metal enclosures. It should be understood that other means of pre-impregnating the metalized cloth could be used, such as hot pressing a thin sheet of the thermoplastic against the cloth sheet to get the plastic to diffuse into it, thus creating a result similar to that using the plastic resin (created by dissolving the thermoplastic in a solvent). This process could be used in a case where the impregnating plastic may not be readily dissolvable in a solvent. It should finally be noted that it is understood that other materials may be added to the impregnating plastic such as ABS, (and particularly where it is dissolved in a solvent) which enhance the electrical and RF characteristics of the cloth layer (and perhaps other desirable properties), and thus further improve the final product. An example of this would be to add copper or aluminum flake to the ABS solution (ie ABS dissolved in acetone or MEK) before it is sprayed onto the cloth.

Another step within the scope of the present invention is to pre-form the pre-impregnated cloth (formed by either of the aforementioned wet resin or hot press methods) to the shape of the mold by heating the somewhat solidified rigid sheet to near the melting point of the pre-impregnating plastic material and either compression or vacuum forming it (or forcing it by some other means) into the desired shape to make it more closely conformal to the injection mold surface in preparation for the injection molding (over-mold) step which creates the final product. This would be particularly useful for applications such as EMI enclosures where the final product has steep walls with sharp (90 degree) corners and edges.

In the above, note that the present invention (using the resin-dissolved thermoplastic steps) has been experimentally tested and proven on Jan. 20, 2010 at C&H Plastics located in Waterville, N.Y. with near-production-quality parts being successfully fabricated. Nickel-coated, non-woven, carbon cloth was pre-impregnated with resin-dissolved ABS and placed in the mold, producing near-perfect formed parts using a number of diverse thermoplastic molding materials. Adjustment of present invention parameters such as melt temperature, mold temperatures, cycle times, plastic additives (such as foaming agents), and plastic coating application methods and layer thicknesses on the metal-coated fiber cloth can be adjusted to optimize product yield and quality. It should be noted that an original assumption that a wet coated (e.g., not completely dried of the solvent carrier) part could be placed in the mold resulted in crazing of the part surface. The assumption that excess solvent such as acetone would evaporate quickly under the extreme heat of the molding process or be absorbed into the melt and evaporate from the part over time after cooling was also not totally accurate. Parts made in this manner seemed to develop a permanent soft surface (sufficiently soft so as to be scratchable with a fingernail) due to an apparent irreversible reaction with the solvent under heating. Thus, it was determined that the present invention comprise the additional step of ensuring the coated fabric be completely dried of all residual acetone before being placed in the mold and over-molded with the hot thermoplastic.

Even though ABS was the only material tested for pre-impregnation of the metalized cloth, it was determined to be compatible with all of the thermoplastic resins used in the molding machine, producing a complete fusion bond, and excellent quality surface finish in all cases. Initial antenna segments (see 10, FIG. 1) were successfully produced with ABS as the molding plastic. These were actually tested for RF reflectivity on an antenna range and performed as well as identically shaped aluminum reflector antennas. Other molding resins which produce parts with higher strength/rigidity and higher heat deflection/operating temperatures were also successfully molded over the ABS-impregnated cloth. These included nylon, glass-filled nylon, polycarbonate, and polyetherimide (a high performance engineering plastic with a melting temperature of 700 degrees F.). One skilled in the art will readily note that practice of the present invention is not limited to the use of these resins.

It should also be noted that accurate die-cutting of the coated cloth to the desired shape prior to placing in the mold, and employing some type of fixturing hardware such as i.e. spring-loaded clips inside the mold which allow the molding machine operator to easily attach and accurately position the cloth in the mold cavity via corresponding holes or tabs die-cut into the cloth, would produce quality parts with a high yield.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for resin-forming electrically conductive and reflective structures, comprising the steps of:
affixing a metalized substrate to a surface of a mold cavity, said cavity having the volume, shape, and dimensions of desired said structure;
conforming said substrate to said surface of said mold cavity;
flowing a first resin mixture into said mold cavity under a predetermined pressure so as to encapsulate said metalized substrate and fill said cavity volume;
applying said pressure for a predetermined duration;
allowing said first resin mixture to solidify; and
removing said structure from said mold cavity.

2. The method of claim 1 wherein said resin mixture is either one of a liquid thermoplastic or a chemically cure-setting liquid composition.

3. The method of claim 1 wherein said metalized substrate is either one of a metalized carbon fiber or metalized fiberglass cloth.

4. The method of claim 3 wherein said metalized substrate is non-woven.

5. The method of claim 4 further comprising the steps of producing said metalized substrate by metal deposition on said either carbon fiber or fiberglass cloth.

6. The method of claim 5 wherein said deposition is vapor deposition.

7. The method of claim 5 wherein said deposition is electroplating.

8. The method of claim 5 wherein said deposited metal is nickel.

9. The method of claim 1 further comprising the step of pre-impregnating said metalized substrate with a second resin mixture compatible with said first resin mixture, prior to said step of affixing said metalized substrate to said surface of said mold cavity.

10. The method of claim 9, wherein said second resin mixture is either one of a chemically cure-setting liquid composition or a solvent-dissolved plastic.

11. The method of claim 1 wherein said step of pre-impregnating said metalized substrate further comprises hot-pressing a thermoplastic substrate into said metalized substrate.

12. The method claim 11 further comprising the step of pre-forming said pre-impregnated metalized substrate so as to conform to the shape of said mold cavity prior to said step of affixing.

13. The method of claim 10 wherein said solvent is acetone.

14. The method of claim 1 wherein said first resin mixture is selected from the group consisting of: acrylonitrile-butadienestyrene (ABS), nylon, glass-filled nylon;
polycarbonate, and polyetherimide.

15. The method of claim 1 wherein said predetermined pressure exceeds 1000 pounds per square inch.
